(19) United States
(12) Patent Application Publication
(10) Pub. No.: US 2003/0112348 A1
(43) Pub. Date: Jun. 19, 2003

(54) Electronic image capture device with frame-and video-specific capture buttons

(75) Inventor: James M. Okuley, Portland, OR (US)

Correspondence Address: MARGER JOHNSON & McCOLLOM, P.C., 1030 S.W. Morrison Street, Portland, OR, 97205, US

(73) Assignee: Intel Corporation (a Delaware corporation), Santa Clara, CA

(21) Appl. No.: 10/025,301

(22) Filed: Dec. 18, 2001

(51) Int. Cl. H04N 5/76

(52) U.S. Cl. 348/231.99

(57) ABSTRACT

An image capture device comprising a camera body and separate still image and video image buttons disposed on the camera body for taking still images and video images respectively and storing said images within a unified memory located in the camera body. The still image button and video image button are spaced apart on the camera body to prevent confusion by the user and to allow a user to take still shots or video shots without needing to perform an intermediate step of placing the camera in still or video modes. The video button is preferably placed on a forwardly facing portion of a handle portion of the main body to allow trigger-like operation of the video camera. The still image button is preferably placed on a top portion of the main body of the camera body to simulate the normal position of such a button on a conventional still camera.

### BACKGROUND OF THE INVENTION

This invention relates generally to electronic image capture devices and, more particularly, to such devices that have both picture and video capture capabilities.

Advances in electronic miniaturization have caused tremendous growth in both digital still cameras as well as digital video devices. The most recent devices have combined the two functions so that users can select to take either a digital still picture or digital (or analog) video.

One such device is known to use the same button for capturing both still and video images. The current method used on this type of camera requires the user to select the different capture modes from an informational LCD, and then use the one main capture button. The current method requires the user to check and then change the capture mode of the camera before capturing stills or video. The capture mode of most cameras is represented by icons on the LCD that are very small and often difficult to see, and in some cases difficult to understand without referring to a user manual. On most of the current cameras, the user is required to scroll through many options in order to switch from still to video capture mode. Without studying the LCD prior to capturing an image, the user does not know if they will capture a video or still when the capture button is pushed, thus the current method provides some users with unwanted results.

Accordingly, the need remains for a digital still/video camera that addresses these usability limitations in the prior art.

### BRIEF DESCRIPTION OF THE DRAWINGS

The objects, features and advantages of the invention will become more readily apparent from the following detailed description of a preferred embodiment of the invention that proceeds with reference to the accompanying drawings.

FIG. 1 is a perspective view of a handheld still/video camera constructed according to a preferred embodiment of the invention;

FIG. 2 is a left side elevation view thereof,

FIG. 3 is a right side elevation view thereof;

FIG. 4 is front elevation view thereof;

FIG. 5 is a back elevation view thereof;

FIG. 6 is a top plan view thereof;

FIG. 7 is a bottom plan view;

FIG. 8 is a block diagram schematic of the invention shown in FIG. 1; and

FIG. 9 is a block diagram schematic showing an alternate embodiment of the invention.

### DETAILED DESCRIPTION

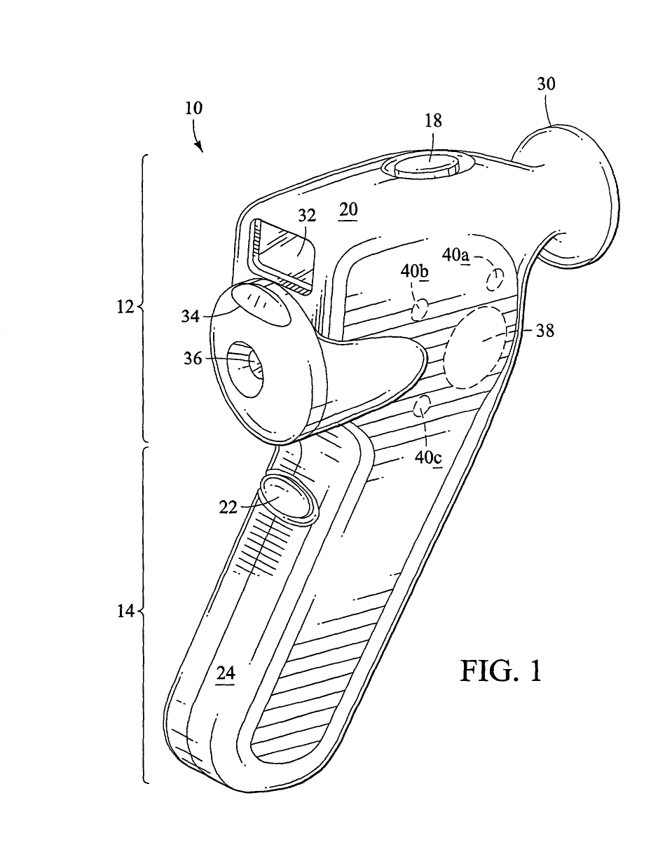

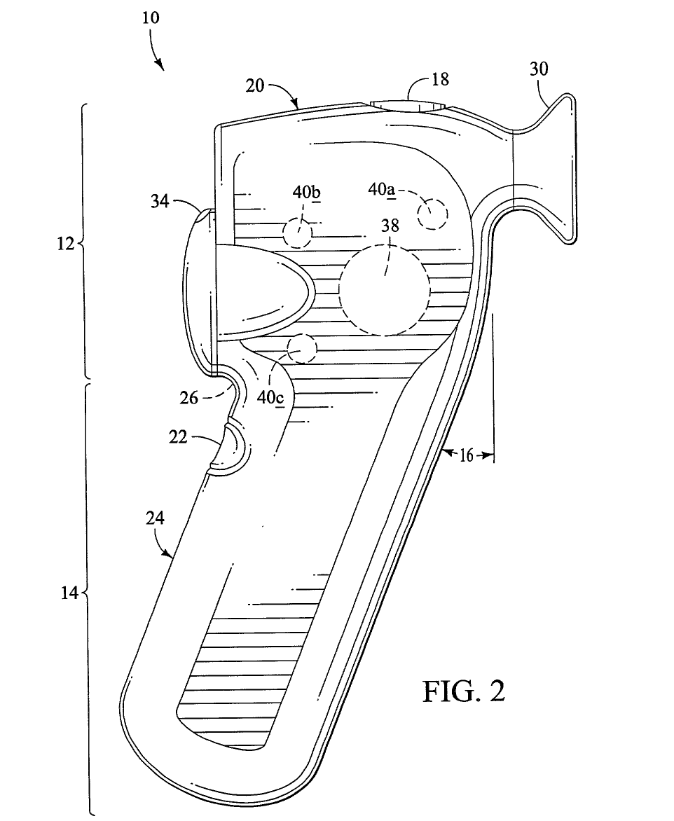

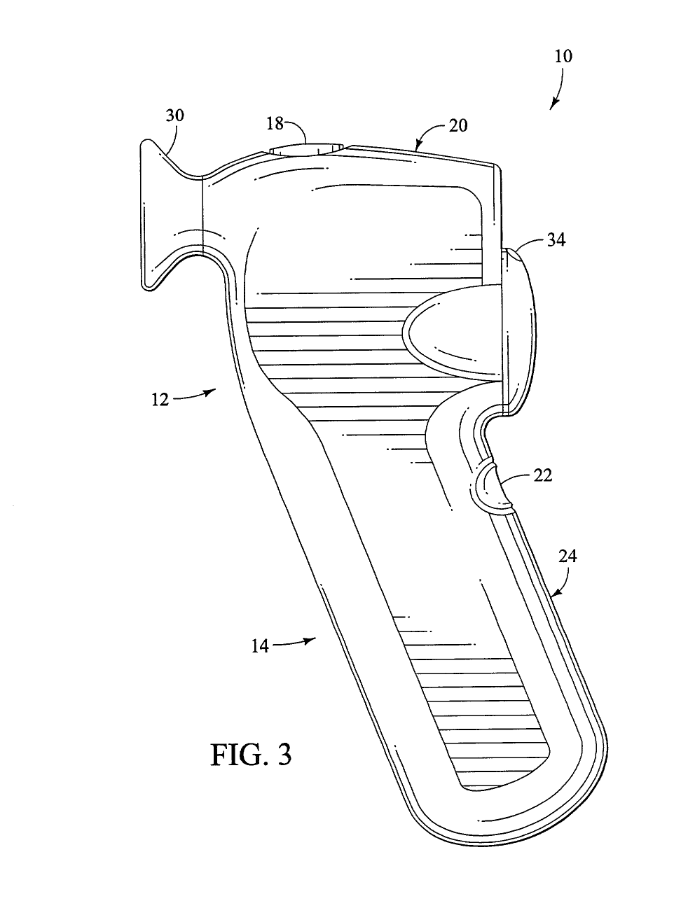

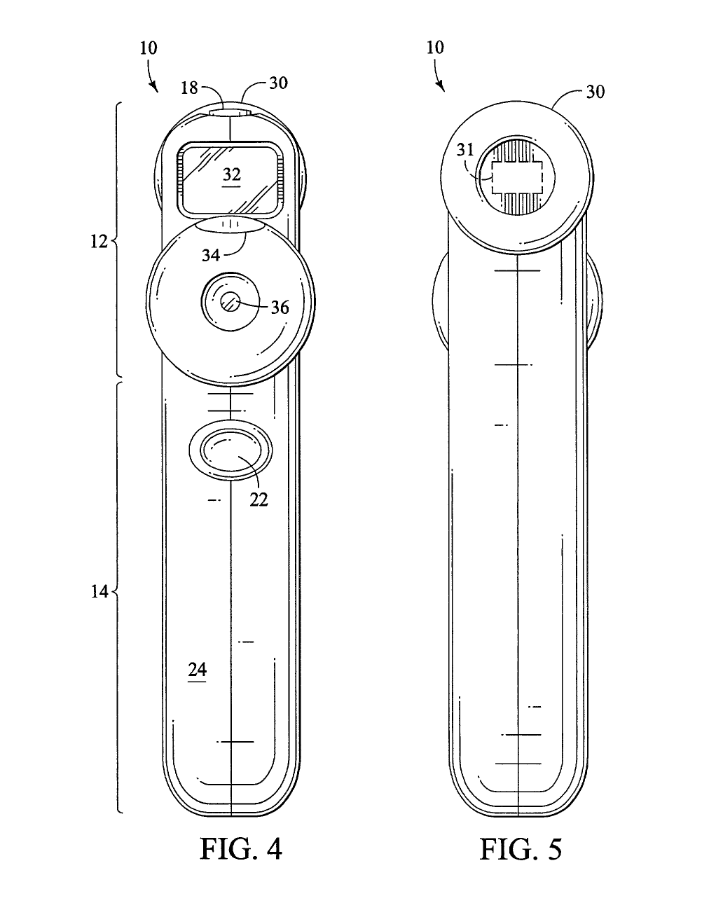

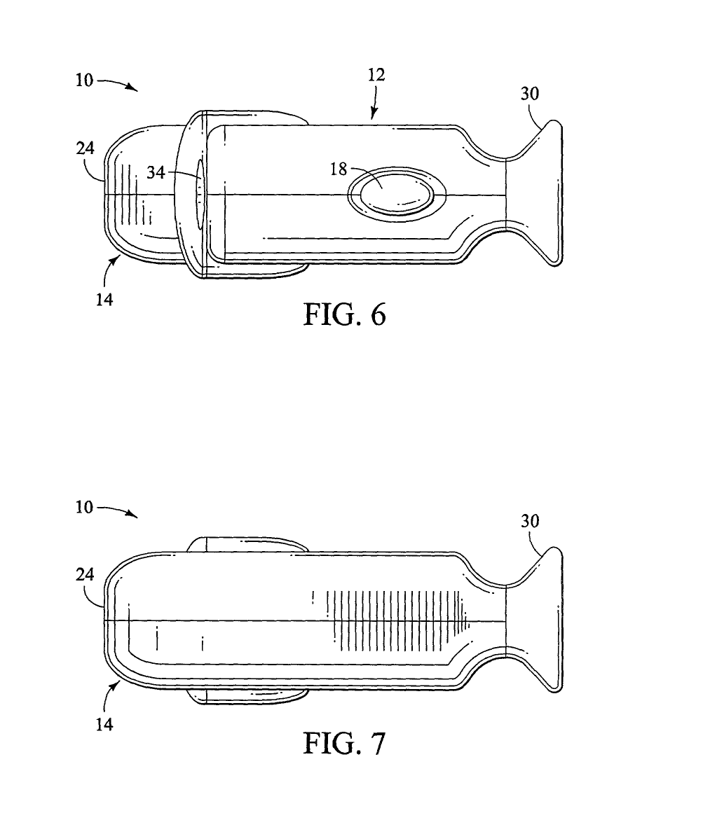

A combination still/video camera embodying the invention is shown in perspective view with camera body 10 in FIG. 1. Camera body 10 includes a main body 12 and an ergonomically designed handle 14 coupled to the body 12 at a lower portion thereof. Handle 14 is preferably coupled to the main body 12 at a slight forwardly facing oblique angle—shown in the side view FIG. 2 as angle 16—and is rounded for comfortable gripping by the hand of the user of the device similar to a reversibly angled pistol-grip.

As will be appreciated, the inventive camera device includes two buttons operative to activate either a still picture capture or video recording. The first button, a still image button 18, is disposed in a first location on the camera body, preferably on a top portion 20 of the main body 12. The second button, a video image button 22, is located in a second location spaced from said first location on the camera body 10, preferably on handle 14 and more preferably on a forwardly-facing portion 24 of the handle 14 adjacent the boundary 26 between the main body 12 and handle 14 so that the video image button 22 can be easily depressed by the index finger of a user when the handle is gripped.

Placement of the buttons according to a preferred embodiment of the invention is important to allow the user to easily distinguish between the button functions. For instance, the video button 22 is preferably placed on the forwardly facing portion of a handle portion of the main body to allow trigger-like operation of the video camera. The still image button is preferably placed on the top portion of the main body of the camera body to simulate the normal position of such a button on a conventional still camera.

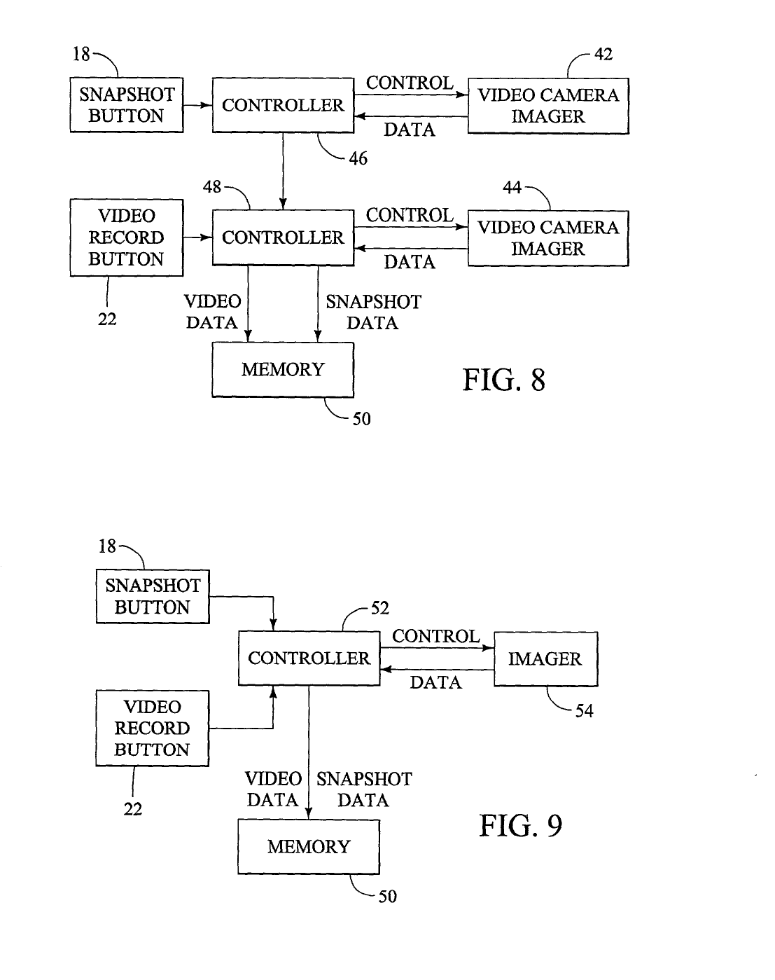

The camera main body 12 includes other features that allow camera 10 to operate as a video and still picture capture device. A viewing aperture through the top of the main body 12 is bounded on one side by a rubber eyecup 30, through which a user looks to center the shot within rectangle 31 (FIG. 5), and a transparent viewfinder 32. A microphone 34 and fixed focus lens 36 are affixed to the front of the main body 12 and coupled to the imaging device and memory, as described further below, to record image and audio data. An optional LCD informational panel 38 and feature control buttons 40a, 40b, and 40c can be included to select and display such information to the user as amount of memory remaining for recording, battery power, playback mode selection, volume control, etc. Speakers (not shown) can also be integrated within the main body 12 for audio playback of a video signal stored in the unified memory 50 (FIGS. 8 and 9).

The handle portion 14 of the camera body can be adapted to contain batteries (not shown) within the hollow interior of the handle to power the device, although the device may be powered by other methods well known in the art and thus not described further here.

Attention is now directed to FIGS. 8 and 9 showing block diagrams of alternate implementations of the recording and storage feature of the device constructed according to the invention. In FIG. 8, the camera is provided with two imagers, a still camera imager 42 and a video camera imager 44. One knowledgeable in the art would recognize that several types of imagers exist, for instance those based on a charge-coupled device (CCD) or one based on complementary metal oxide semiconductor (CMOS). In the two-imager device, the still camera imager 42 typically takes pictures at higher resolution (e.g. 2.1 or 3.3 megapixels) than is required for video imagery. Consequently, the CCD or CMOS imaging device used in video camera imager 44 has a lower resolution (typically 480 lines of resolution) but takes pictures at thirty frames per second whereas the still camera imager 42 takes pictures one at a time rather than in quick succession.

Each imager 42, 44 in the FIG. 8 device is under the control of a corresponding controller 46, 48 that operates in cooperation with snapshot button 18 and video record button 22, respectively. When the camera 10 is turned on, buttons 18, 22 are placed in a ready state awaiting actuation. When a user depresses snapshot button 18, controller 46 receives a signal that the button has been depressed and in turn sends a control signal to still camera imager 42 to activate and send data back through data line to controller 46 and onward to unified memory 50 comprising hard disk, flash, or some other nonvolatile memory technology.

Several methods are contemplated for controller 46 operation. In a first method, depressing snapshot button 18 causes a high (1) signal to be sent to controller 46 for as long as button 18 is depressed. When the button is released, the signal returns to a low (0) signal state. Each low-to-high signal transition will cause the controller 46 to operate the still camera imager 42 and hence receive a signal still image shot, which is then storied in memory 50 in a known format such as “jgp” or “tiff”. The controller can operate also to take an image for each fraction of a second that the snapshot button 18 is depressed—for instance, three times for every second that button 18 is depressed. Controller 48 is coupled to video record button 22 and is adapted to send a control signal to video camera imager 44 for as long as the video record button 22 is depressed. For instance, if the video imager 44 takes thirty frames a second and the video record button 22 is depressed for two-and-a-half seconds, then the video camera feature captures 75 frames, which are then stored in memory 50 under known formats such as those promulgated by the motion pictures expert group (MPEG). Alternately, the controller 48 can be set to start the video camera imager record feature upon the first low-high transition detected from video record button 22, and stop the imager upon the second low-high transition. That way, the video camera feature starts when the video record button 22 is pressed a first time and stopped when it is pressed a second time.

FIG. 9 illustrates the still image/video capture device electronics in a high level block diagram form according to an alternate embodiment of the invention. Both snapshot button 18 and video record button 22 are coupled to a single controller 52, which operates a single imager 54 according to whether a low-high transition signal was received from button 18 or button 22. As with the device in FIG. 8, a low-high transition received from snapshot button 18 causes controller 52 (programmed in software or firmware) to send a control signal to imager 54 to take a single image, which is then returned along data line and stored in memory 50 in an appropriate format. Similarly, a low-high transition received from video record button 22 causes controller 52 to send a control signal to imager 54 to take a sequence of pictures (30 frames/second) for as long as button 22 is pressed and a high signal state is received. The data returned along data line to controller 52 following a video record function is then stored in memory 50 in an appropriate format.

The method for operation of the invention incorporating the two function buttons 18, 22 thus allows a single still image to be stored in the unified memory 50 responsive to actuation of one 18 of the buttons and a video to be stored in the unified memory 50 responsive to actuation of the other 22 of the two buttons without having the perform any intermediate steps such as flipping a switch to place either the snapshot button 18 or video record button 22 in a ready state. Both buttons 18, 22 are thus simultaneously active awaiting actuation and the user can selectively take either a still picture or video simply by pressing a corresponding button.

Having described and illustrated the principles of the invention in a preferred embodiment thereof, it should be apparent that the invention can be modified in arrangement and detail without departing from such principles. Accordingly, we claim all modifications and variation coming within the spirit and scope of the following claims.

What is claimed is:

1. An image capture device comprising:
a camera body,
a still image button disposed in a first location on the camera body;
a video image button in a second location on the camera body, said second location different from said first location; and
a unified memory coupled to said still image button and said video image button for storing a still image or a video image, respectively, responsive to activation of said respective button.

2. The apparatus of claim 1, wherein the camera body includes a main body and a handle coupled to said main body, said handle adapted to be griped with the hand of a user.

3. The apparatus of claim 2, wherein the still image button is disposed on said main body and the video image button is disposed on the handle.

4. The apparatus of claim 3, wherein the still image button is disposed on a top portion of said main body and the video image button is disposed on a forwardly facing portion of the handle adjacent the boundary between the main body and handle so that the video image button can be easily depressed by the index finger of a user when the handle is gripped.

5. The apparatus of claim 2, said handle coupled to said main body at a slight, forwardly facing oblique angle to said main body.

6. An image capture device comprising:
a camera body including a main body and a handle coupled at a slight forwardly oblique angle to the main body, said handle adapted for gripping by the hand of a user;
a viewfinder integrated into said main body;
a still image button disposed in a first location on the camera body;
a video image button in a second location on the camera body, wherein at least one of said still image button and said video image button is disposed on a forwardly facing portion of said handle; and
a unified memory coupled to said still image button and said video image button for storing a still image or a video image, respectively, responsive to activation of said respective button, wherein said still image button and said video image button are simultaneously active awaiting actuation.

7. The apparatus of 6, wherein the still image button is disposed on said main body and the video image button is disposed on the handle.

8. The apparatus of claim 6, wherein the still image button is disposed on a top portion of said main body and the video image button is disposed on a forwardly facing portion of the handle adjacent the boundary between the main body and handle so that the video image button can be easily depressed by the index finger of a user when the handle is gripped.

9. A method for capturing still and video images from a single image capture device of a type having a camera body, two spaced buttons disposed on the camera body and a unified memory, the method comprising:
storing a single still image in the unified memory responsive only to actuation of a first of the two buttons; and
storing a video in the unified memory responsive only to actuation of a second of the two buttons, wherein both buttons are simultaneously active awaiting actuation.

10. The method of claim 9, further including providing a handle for the camera body and allowing the user to grip the handle for camera use.

11. The method of claim 10, further including locating at least one of the first or second buttons on a forwardly facing portion of the handle for easy triggering by the forefinger of the user's hand when gripping the camera handle.

12. The method of claim 9, wherein the steps of storing the single still image and video in the unified memory occur concurrently without any intermediate steps.
